(19) United States
(12) Patent Application Publication
(10) Pub. No.: US 2010/0057741 A1
(43) Pub. Date: Mar. 4, 2010

(54) SOFTWARE RESOURCE ACCESS UTILIZING MULTIPLE LOCK TABLES

(75) Inventors: Nelson W. Fincher, San Jose, CA (US); Terri A. Menendez, Morgan Hill, CA (US)

Correspondence Address: CANTOR COLBURN LLP - IBM TUSCON DIVISION, 20 Church Street, 22nd Floor, Hartford, CT, 06103, US

(73) Assignee: INTERNATIONAL BUSINESS MANAGEMENT PRODUCTIONS, Armok, NY (US)

(21) Appl. No.: 12/201,351

(22) Filed: Aug. 29, 2008

(51) Int. Cl. G06F 17/30

(52) U.S. Cl. 707/8; 707/E17.007

(57) ABSTRACT

A computing system includes a plurality of coupled computing systems, a centralized server and a data set. The system also includes a data sharing controller which includes a primary lock structure that is coupled to the data set when an address space for the data set is allocated and a plurality of secondary lock tables. Each secondary lock table is assigned to a different portion of the data set.

### BACKGROUND

The present invention relates to resource management, and more specifically, to controlling access to software resources utilizing multiple lock structures.

In computer science, a lock is a synchronization mechanism for enforcing limits on access to a resource in an environment where there are many threads of execution. As such, locks are one way of enforcing concurrency control policies.

Resource access and concurrency becomes even more important when multiple computers are sharing the resources. As used herein, the terms “coupled computers” shall refer to any two or more processors that share some or all of their resources. One example of coupled computers may be referred to as a systems complex. A systems complex, sometimes called a “Sysplex,” is one or more (up to 32 logical partitions) processors joined into a single unit, sharing the same Sysplex name and data sets. Put another way, a Sysplex is an instance of a computer system running on one or more physical computers. Sysplexes can be broken down into LPARs, or logical partitions, each running its own operating system.

Previous solutions for controlling access to software resources in coupled computer systems have used a lock table structure maintained by a data sharing controller. These solutions use a single lock structure per address space. An example of this type of implementation is the IBM virtual storage access method (VSAM) that utilizes a record lock structure. This solution provides valuable functionality, but creates a single point of failure. When the address space is unavailable, the software resources needing management are unavailable.

### SUMMARY

One embodiment of the present invention is directed to a coupled computing system that includes a plurality of computing systems, each computing system including a central processor and connected to each of the other computing systems. The system of this embodiment also includes a centralized server coupled to each of the plurality of interconnected computing systems and a data set coupled to the plurality of computing systems and the centralized server. The system also includes a data sharing controller coupled to the plurality of computing systems, the centralized server and the data set, the data sharing controller being configured to manage access to the data set by the plurality of computing systems. The data controller includes a primary lock structure that is coupled to the data set when an address space for the data set is allocated and a plurality of secondary lock tables, each secondary lock table being assigned to a different portion of the data sets, wherein each of the plurality of secondary lock tables is not connected to the data set until a resource in the portion of the data set to which a particular lock table is assigned is requested.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a schematic diagram of an exemplary coupled computing system according to one embodiment of the present invention;

FIG. 2 shows an example of multiple lock tables according to one embodiment of the present invention;

FIG. 3 is a flow diagram of an exemplary method for managing resource sharing in a coupled computing system according to one embodiment of the present invention; and

FIG. 4 is a flow diagram of another exemplary method for managing resource sharing in a coupled computing system according an alternative embodiment of the present invention.

### DETAILED DESCRIPTION

Embodiments of the present invention are directed to a system of coupled computers that share the same data sets. Access to data sets is controlled by multiple lock structures. In contrast to the prior art where a single lock structure (implemented, typically as a table) controlled access to all data sets. Each of the multiple lock structures of the present invention may control access to one or more of the data sets.

In one embodiment, the use of multiple lock structures (also typically implemented as a table) allows a system designer/user to create multiple lock structures to be managed by a data sharing controller. These lock structures are called secondary lock structures. The secondary lock structures allow users to segment application resources managed by data sharing controller. This provides the ability to separate test from production applications.

In one embodiment, the use of multiple lock structures controls the access and management of the data sharing controller lock structures to provide applications with access to software resources where serialized control is needed. This capability simplifies shared access to required software resources. A primary lock structure implemented may be configured to control shared resources as well as providing a centralized repository of locks needed for multi-system sharing protocols. The secondary lock structures are connected when needed. That is, while the primary lock structure is connected at address space initialization and is always available, secondary lock structures are only connected when locks are being referenced. In one embodiment, this may allow a user the ability to separate application access to a particular lock structures.

In more detail, the secondary lock structures are connected when a data set needing management by the data sharing controller is opened. Thus, the resources for the connection are not utilized until the data is actually needed. This may reduce system overhead for maintaining connections to seldom used data sets.

In one embodiment, the data set is logically bound to a secondary lock structure. The required binding is indicated by the users storage management policy. In one embodiment, the storage class definition contains a new value for “Lock Set”. The Lock Set name is defined in the storage management base configuration. The Lock Set contains the name of the lock structure for the logical binding of the data set and lock structure. A lock set can contain the name of the primary lock structure as well. If a storage class definition does not contain a lock set, then the logical binding is for primary lock structure. This can be used as a migration path for staged usage of multiple lock structures. After the name of the lock structure has been obtained, the lock structure is connected and the supporting task structure is attached. The connection remains as long as the address space is viable. In one embodiment, the address space must be terminated in order to delete the connection.

In one embodiment, each lock structure is managed by a single task structure. This task structures supports the event notification and processing as well as the rebuild support needed for the data sharing controller.

In one embodiment, the multiple lock structures are defined in the configuration resource management (CFRM) policy prior to connection. The CFRM policy is an external facility not managed by the present invention.

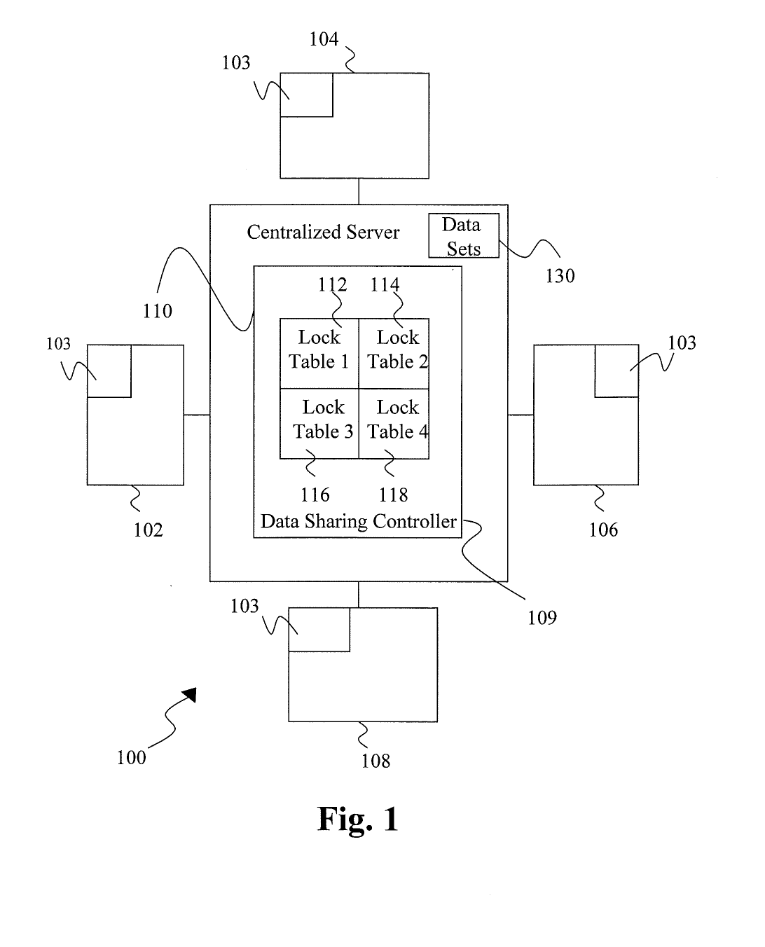

FIG. 1 shows an example of a system 100 according to one embodiment of the present invention. The system 100 includes plurality of computing systems coupled to one another to form a systems complex. In this example, the computing system includes a first computing system 102, a second computing system 104, a third computing system 106, a fourth computing system 108 and a fifth computing system 109. In one embodiment, each computing system may include one or more central processors 103.

As shown, the system 100 is connected in a so-called “hub and spoke” configuration with the fifth computing system 109 (centralized server) serving as the hub and the other computing systems being spokes. This configuration is by way of example only and does not limit how the computing systems may be linked together.

In one embodiment, the system 100 includes a shared data set 130. The shared data set 130 may be accessed on one or more computing systems. The shared data set 130 may be stored, for example, on the centralized server 109. Of course, shared data set 130 may be distributed among two or more of the computing systems.

Access to the shared data set 130 is controlled by the data sharing controller 110. It will be understood that each computing system may include a data sharing controller. In particular, the data sharing controller 110 maintains two more lock tables which, when requested by a particular process, lock data/resources in the shared data set 130 from access by another process. The data sharing controller 110 may, in one embodiment, implement system managed storage functions.

Of course, according to embodiments of the present invention, multiple types of locks may be maintained. Non-limiting examples of such locks include a Null Lock (NL) which indicates interest in the resource, but does not prevent other processes from locking it; a Concurrent Read (CR) which indicates a desire to read (but not update) the resource; a Concurrent Write (CW) which indicates a desire to read and update the resource and allows other processes to read or update the resource, but prevents others from having exclusive access to it; a Protected Read (PR) that is the traditional share lock, which indicates a desire to read the resource but prevents other from updating it; a Protected Write (PW) that is the traditional update lock, which indicates a desire to read and update the resource and prevents others from updating it; and an Exclusive (EX) that is the traditional exclusive lock which allows read and update access to the resource, and prevents others from having any access to it.

The lock tables may have a primary lock table (shown as lock table 1 112) that is utilized to control shared resources as well as a centralized repository of needed for multi-system sharing protocols. This primary lock table (lock table 1 112 may be connected to the shared data set 130 when the address space for the shared data set is allocated and may always be available. The secondary lock structures (lock table 2 114, lock table 3 116 and lock table 4 118) are connected to one or more of the data sets 130 when those data sets require control by the data sharing controller 110. That is, each secondary lock structure is not connected at allocation time but, rather, is connected when a process requests access to the shared data set 130 to which the particular secondary lock table is assigned. In this manner, connection overhead is not created until it is needed.

In operation, each record, file or the like stored in the shared data set may include an indication of which lock table it is assigned to. A process requesting to lock a particular record examines a portion of the record to determine the proper lock table to access. The lock is then set in the lock table associated with the particular record.

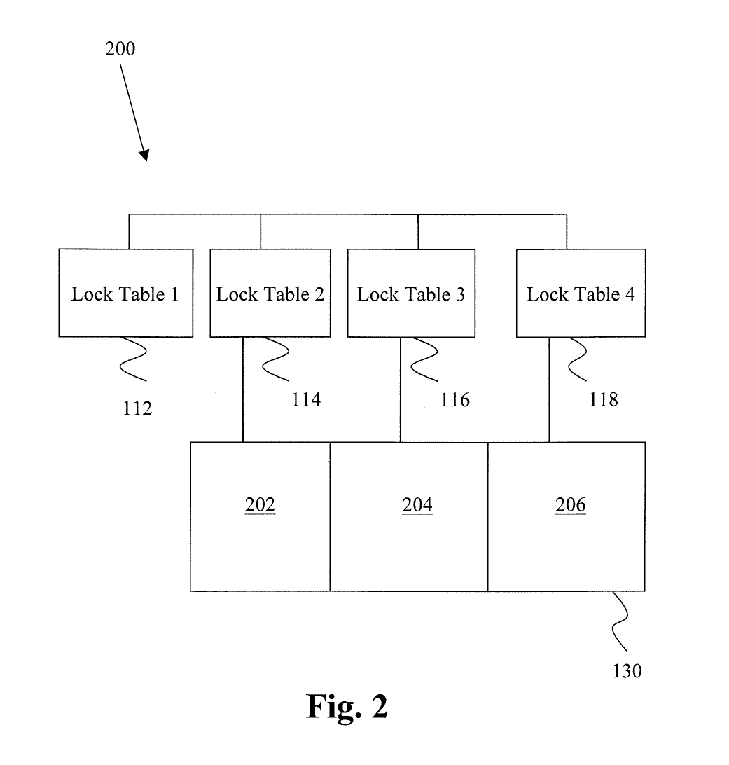

FIG. 2 shows an example of a structure 200 of lock tables according to one embodiment of the present invention. As shown, the primary lock table (lock table 1 112) is hierarchically at a higher level than the other lock tables. Lock table 2 is assigned to a first portion 202 of the shared data set 130, lock table 3 is assigned to a second portion 204 of the shared data set 130 and lock table 4 is assigned to a third portion of the shared data set 130. Distributing the lock structures in as shown may help alleviate single point of failure issues existing if only one lock structure was used.

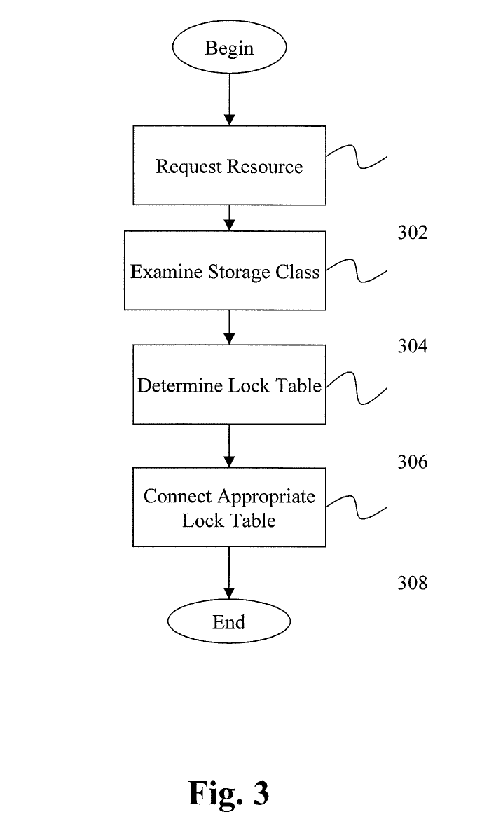

FIG. 3 shows a method according to one embodiment of the present invention. The method shown in FIG. 3 shows on example of a process by which a process can lock certain data.

At a block 302, the particular resource (e.g., data) is requested. This request may include accessing a data sharing controller to determine the location of the particular resource. While the resource may be requested, if the resource is already locked, depending on the type of lock, the resource may not be available.

Assuming that the resource is available, at a block 304 the storage class of the requested record is examined. The storage class indicates which lock table of the multiple lock tables the particular resource is assigned to. Thus, the lock table to which the particular resource is assigned is determined at a block 306.

At a block 308, the particular type of lock requested by the request is stored in the appropriate lock table at a block 308. Of course, when the lock is no longer needed, the process may “free” the lock, also at a block 308.

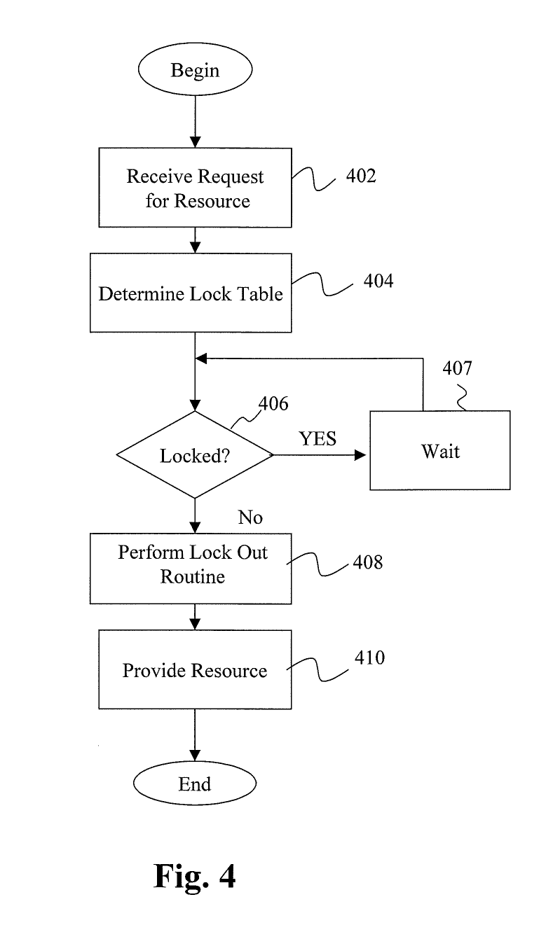

FIG. 4 shows another method according to one embodiment of the present invention. In particular, the method shown in FIG. 4 illustrates a process that may be implemented when a particular resource is locked.

At a block 402, a particular resource is requested by a requesting process and received, for example, by a data sharing controller. This request may include accessing the data sharing controller to determine the location of the particular resource.

At a block 404, the lock table for the requested resource is determined. This may be accomplished, for example, by examining the storage class for the resource.

At a block 406, it is determined if the particular resource is locked. If so, at block 407 the process waits and returns to block 406. This repetition occurs until the resource becomes available. Of course, in another embodiment, the request may be terminated if the resource is locked. Regardless, when the resource is available, at a block 408, a lock out routine is performed. The particular lockout routine performed will depend on the type of lock applied to the resource. Various lockout routines are known in the prior art. In one embodiment, the lockout routine may include waiting for locked resource to become available.

At a block 410, the requested resource is made available. Of course, if the request includes the need to place a lock on the request, some or all of the process shown in FIG. 3 may then be performed.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

As described above, the embodiments of the invention may be embodied in the form of computer-implemented processes and apparatuses for practicing those processes. Embodiments of the invention may also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A coupled computing system, the system comprising:
a plurality of computing systems, each computing system including a central processor and connected to each of the other computing systems;
a centralized server coupled to each of the plurality of interconnected computing systems;
a data set coupled to the plurality of computing systems and the centralized server; and
a data sharing controller coupled to the plurality of computing systems, the centralized server and the data set, the data sharing controller being configured to manage access to the data set by the plurality of computing systems, the data controller including:
a primary lock structure that is coupled to the data set when an address space for the data set is allocated; and
a plurality of secondary lock tables, each of the plurality of secondary lock tables being assigned to a different portion of the data sets, wherein each of the plurality of secondary lock tables is not connected to the data set until a resource in the portion of the data set to which a particular lock table is assigned is requested.
